(19) United States
(12) Patent Application Publication
(10) Pub. No.: US 2003/0126258 A1
(43) Pub. Date: Jul. 3, 2003

(54) Web based fault detection architecture

(76) Inventors: Gary W. Conkright, Naperville, IL (US); Joseph Hasiewicz JR., Glen Ellyn, IL (US); James Paul Herzog, Downers Grove, IL (US)

Correspondence Address: MICHAEL BEST & FRIEDRICH LLC, 401 NORTH MICHIGAN AVENUE, SUITE 1700, CHICAGO, IL, 60611-4212, US

(21) Appl. No.: 10/328,254

(22) Filed: Dec. 23, 2002

Related U.S. Application Data
(63) Continuation-in-part of application No. 09/791,097, filed on Feb. 22, 2001.
(60) Provisional application No. 60/183,899, filed on Feb. 22, 2000.

(51) Int. Cl. G06F 15/173; G06F 15/00; G06F 11/00

(52) U.S. Cl. 709/224; 702/188

(57) ABSTRACT

A remote analysis system for equipment condition monitoring and the like, using a data acquisition device operable at the remote site of monitored equipment, a wide area network for communication of data to an analysis server, and an empirical model for analyzing operational performance based on data from the device. An information processor such as a personal computer (PC) or an embedded processor application is coupled to the data acquisition device for collecting signals indicative of the monitored machine or process. A communications network, such as a wireless or telephony network, or a wide area network application such as an intranet or the Internet, facilitates communications to an analysis server for conveying the collected signals to an application service provider (ASP) for analysis of the remotely monitored site. A communications server may also be used for facilitating communications via a number of different communications networks. A notification server is provided responsive to the analysis server for completing a notification procedure for a customer subscribing to the ASP services for remote analysis with the data acquisition device at the process-monitoring site. The customer may be notified through a variety of electronic or telephonic communication methods, including, e-mail, facsimile, telephone calls, or subscriber dial-up and the like.

### CROSS-REFERENCE TO RELATED APPLICATION

This application is a continuation-in-part of prior U.S. application Ser. No. 09/791,097, filed Feb. 22, 2001, which is based upon and claims the benefit under 35 U.S.C. §119 of prior U.S. Provisional Application No. 60/183,899, filed Feb. 22, 2000.

### BACKGROUND OF THE INVENTION

1. Field of the Invention

The present invention relates to a remote analysis system, and more particularly to a web based fault detection architecture facilitating communications to a remote analysis computer for providing analysis applications for a monitored process or machine.

2. Description of the Related Art

Presently, analysis equipment for monitoring processes associated with various industrial systems employ a computer system, or a microprocessor-based dedicated system local to the data acquisition device for the analysis and monitoring of such processes for fault detection and integrity of system operation. While it is known to provide communications capabilities for distributed local monitoring equipment and sensor devices, such communications capabilities typically only provide for the remote reporting of preprocessed data from various locations. However, there are numerous costs and duplication of software and hardware associated with the known distributed analysis systems, and additionally the use of distributed local computer systems for analysis and processing of collected data cannot take advantage of concurrent and historical data collected for processing at other localities.

This is typified for example in the context of equipment monitoring for a fleet of similar assets, as in a fleet of aircraft, rental cars, locomotives, tractors, and the like. Each asset is highly mobile, and may additionally have limited on-board computing power available for any kind of local equipment condition monitoring. Furthermore, persons charged with the responsibility of monitoring, servicing and maintaining such assets are invariably located remotely from the assets. Quite often, several parties are commonly responsible for this, and are themselves not co-located. There is a need for equipment condition monitoring for mobile equipment that provides computing power sufficient for advanced analysis, as well as remote access by authorized parties to the results of the monitoring.

It would be desirable therefore to provide a local system which collects data from a combination of remote data acquisition devices, which may include programmed or smart devices as well as dumb devices which merely provide a conduit for data collected as being indicative of the monitored processes or machines. Furthermore, it would be advantageous to provide a server architecture that facilitates communication, analysis, and notification functions by a service provider which may take advantage of programming capabilities which may not be locally available, as well as concurrent and historical databases for providing enhanced processing of collected data.

A variety of new and advanced techniques have emerged in industrial process control, machine control, system surveillance, and condition based monitoring to address drawbacks of traditional sensor-threshold-based control and alarms. The traditional techniques did little more than provide responses to gross changes in individual metrics of a process or machine, often failing to provide adequate warning to prevent unexpected shutdowns, equipment damage, loss of product quality or catastrophic safety hazards.

According to one branch of the new techniques, empirical models of the monitored process or machine are used in failure detection and in control. Such models effectively leverage an aggregate view of surveillance sensor data to achieve much earlier incipient failure detection and finer process control. By modeling the many sensors on a process or machine simultaneously and in view of one another, the surveillance system can provide more information about how each sensor (and its measured parameter) ought to behave. Additionally, these approaches have the advantage that no additional instrumentation is typically needed, and sensors in place on the process or machine can be used.

An example of such an empirical surveillance system is described in U.S. Pat. No. 5,764,509 to Gross et al., the teachings of which are incorporated herein by reference. Therein is described an empirical model using a similarity operator against a reference library of known states of the monitored process, and an estimation engine for generating estimates of current process states based on the similarity operation, coupled with a sensitive statistical hypothesis test to determine if the current process state is a normal or abnormal state. Other empirical model-based monitoring systems known in the art employ neural networks to model the process or machine being monitored.

It would be advantageous to deploy simple means of communicating data from such in-place sensors to a remote location where sufficient processing power could be used to analyze the data according to such new techniques, and present the results to a remote viewer at a location possibly distinct from the location of the monitored process or machine.

### SUMMARY OF THE INVENTION

The present invention relates to a web based fault detection architecture enabling the collection of data from devices providing data for remote analysis, using a service provider's servers for communication, analysis, and notification, and thus providing a customer with a detailed cost effective approach for analysis remote from a device site. The analysis server approach using wide area networks (WANs) such as the Internet or an intranet via telephony networks or the like facilitates the remote analysis of the monitored processes, which may provide analysis algorithms and techniques not readily available in a local device. A wide variety of applications including industrial, medical, and other commercial applications provide analysis information for the customer with minimal processing or preprocessing associated with the data acquisition device operable at the process monitoring site. Accordingly, an application service provider (ASP) model is facilitated with the described network based architecture employing one or more central databases to facilitate better technical and data analysis approaches than may be available at the local data acquisition device. The present invention is ideal for advanced condition monitoring of expensive fleet assets such as aircraft, rental cars, locomotives, tractors, and the like.

According to one embodiment, the analysis server builds an empirical model of operational states of the remotely monitored process or machine, from data gathered from the process or machine. In a monitoring mode, this empirical model provides a baseline for how the process or machine ought to be operating. The empirical model can employ a new advantageous similarity-based technique for making estimates of the baseline parameters. A decision engine comprising the analysis server employs a sensitive statistical hypothesis testing technique to determine at an earliest possible time whether the remotely monitored process or machine is deviating from known or acceptable operating states.

Briefly summarized, the present invention relates to a remote analysis system using a data acquisition device operable at a process or machine operating site. An information processor is coupled to the data acquisition device for collecting signals indicative of the monitored process, and a communications network, such as a wireless or telephony network, or a wide area network (WAN) application facilitates communications to an analysis server for conveying the collected signals to an application service provider (ASP) for remote analysis of the monitored process. The analysis server provides equipment condition monitoring by means of modeling process or machine operation using data-driven, i.e., empirical, modeling methods, particularly nonparametric modeling methods. A communications server facilitates communications via a number of different communications networks, and a notification server is provided responsive to the analysis server for completing a notification procedure for a customer subscribing to the ASP services for remote analysis with the data acquisition device at the process monitoring site. The customer may be notified using a variety of electronic or conventional communication methods.

### BRIEF DESCRIPTION OF THE DRAWINGS

The novel features believed characteristic of the invention are set forth in the appended claims. The invention itself, however, as well as the preferred mode of use, further objectives and advantages thereof, is best understood by reference to the following detailed description of the embodiments in conjunction with the accompanying drawing, wherein:

FIG. 1 is an Internet based fault detection architecture facilitating a remote analysis system in accordance with the invention;

FIG. 2 shows a flowchart of steps for implementing monitoring according to the invention;

FIG. 3 illustrates geometrically a similarity operator for empirical modeling of a monitored process or machine according to the invention;

FIG. 4 illustrates sensor data and a method for distilling the data to a reference set for modeling; and

FIG. 5 illustrates a remote processing architecture of the invention for quasi-batch processing in an asynchronous messaging environment such as the Internet.

### DETAILED DESCRIPTION OF PREFERRED EMBODIMENTS

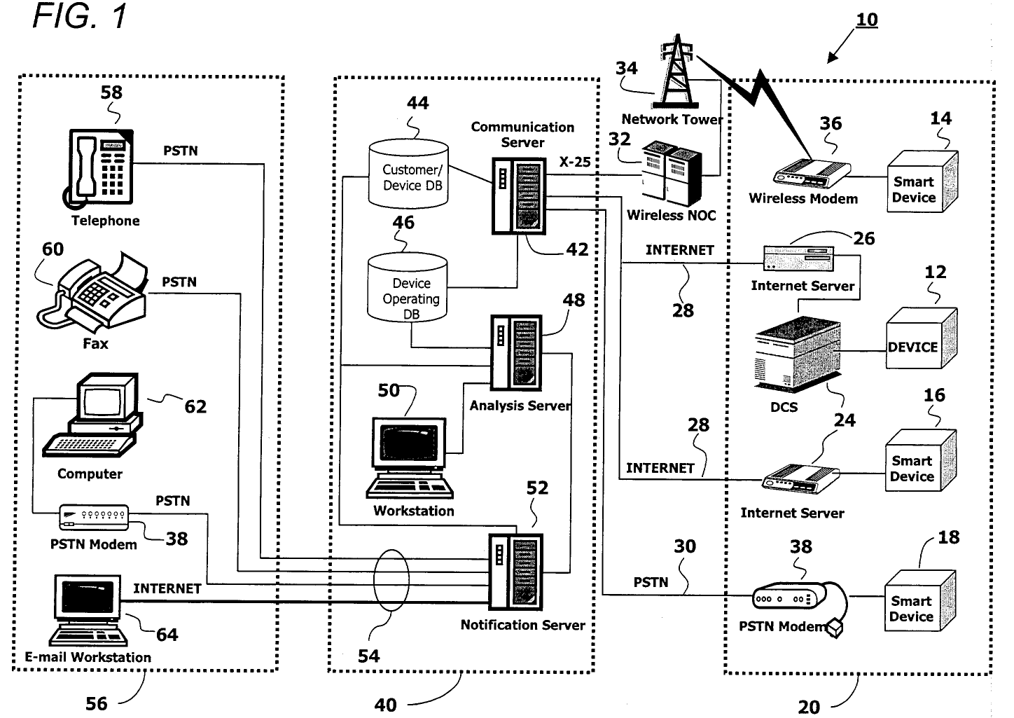

A remote analysis system 10, as shown in FIG. 1, facilitates a network based fault detection architecture in which multiple data acquisition devices 12 which may include smart devices 14, 16, and 18 are located at a device site 20. The smart devices 14, 16, and 18 may include a personal computer (PC) having a data acquisition board, while the device 12 may reside with an embedded processor architecture using a microcontroller or microprocessor with more limited programming capabilities. As illustrated, the device 12 may communicate through a distributed control server 24 to an Internet server 26 via the Internet 28 which may be provided as one or more communications networks which may include a telephony network such as the public switch telephone network (PSTN) 30 or a wireless network 32. As shown, the wireless network 32 communicates via a network tower 34 to a wireless modem 36 for data communications with the smart device 14. The PSTN 30 telephony network on the other hand may employ a conventional modem 38 for communications, e.g., with the device 18.

The application service provider's locality (ASP facility) may include one or more servers, which as shown, the ASP 40 provides a communications server 42 having access to a customer/device database 44 and a device operating database 46 for communication with the device site 20 via the various communications networks including the Internet 28, PSTN 30, wireless network 32, or any other wide area network (WAN) associated with the device site 20. The communication server 42 facilitates communication via the communications networks to, e.g., an information processor such as the PC or microprocessor associated with the devices at the device site 20 for collecting signals indicative of the monitored process. The communication server 42 and device operating database 46 facilitate the use of the collected signals at an analysis server 48 which may include a work station terminal 50. The analysis server facilitates the conveying of the collected signals via the communications network for use by the ASP 40 for remote analysis of the monitored processes. Accordingly, the analysis server 48 may provide a wide variety of computationally intensive operations for analysis of the monitored signals including pattern recognition, modeling, digital signal processing, and filtering. To this end, the information processor associated with, e.g., device 12 may provide more limited processing capabilities, or may employ the use of a trigger associated with processing for sensing, e.g., a data alarm with a predetermined threshold, e.g., 10%, for dumping data via the communications network to the analysis server 48 for a more detailed analysis of the collected signals.

The customer/device database 44 and the analysis server 48 are coupled to a notification server 52 which facilitates communications through a notification communications network 54, which may also be provided with WAN or telephony communications networks for providing information to the customer 56 via one or more of a telephone 58, facsimile 60, computer 62, or an e-mail workstation 64.

There are up to three physical locations for the scheme described herein: (1) the site where the device(s) 12, 14, 18 being monitored are located 20; (2) the location of the remote analysis system servers and analyst, ASP 40; and (3) the location(s) where the analysis is to be sent, customer 56. In the scheme for the device site, there are at least four different methods for device operating information to be sent to the remote analysis system for processing.

The smart devices 14, 16, 18, running remote analysis system thin client embedded software, determines that criteria has been satisfied, requiring a posting of information on the operating status of the device, and/or attached devices, and sends an operating data file to the remote analysis system IP address. Raw data can be processed locally if needed to minimize remote communication using the remote analysis system embedded software, which may look for particular operating conditions (same state; non-transient; time-out) prior to transmission of data. Communication from the device to the Internet Server, also located at the site, occurs through an Ethernet network, or other existing network system.

The local DCS system collects sensor data from a combination of “Smart” and dumb devices. This data is made available to either a remote analysis system program running within the DCS system, or to a PC that is running in parallel with the DCS. When the DCS/PC determines that criteria have been satisfied, requiring a posting of information on the operating status of one or more attached devices, it sends an operating data file to the remote analysis system IP address. Raw data can be processed locally at the DCS to PC to minimize remote communication. This can be a periodic event, as when a snapshot of data is provided once per ten minutes from raw data that is being gathered every second; or can be based on a complex set of criteria, including that data is only sent once process transients have damped out after process set points have been adjusted. Communication from the DCS or PC to the Internet Server occurs through an Ethernet network, some other existing network system, or through a direct Internet connection.

The smart device with an integrated wireless modem, running remote analysis system thin client embedded software, determines that criteria has been satisfied, requiring a posting of information on the operating status of the device, and/or attached devices, and sends an operating data file to the remote analysis system via a wireless modem. Raw data can be processed locally, to minimize remote communication, using the remote analysis system embedded software. By way of example, the smart device may operate on an aircraft and collect a snapshot of data on turbine performance for transmission only when the aircraft is in a specified operational state, such as take-off or cruise modes.

The smart device with an integrated PSTN modem, running remote analysis system thin client embedded software, determines that criteria has been satisfied, requiring a posting of information on the operating status of the device, and/or attached devices, and sends an operating data file to the remote analysis stem via a wireless modem. Raw data can be processed locally, to minimize remote communication, using the remote analysis system embedded software. By way of example, a household appliance can contain a smart data-recording device that uses the household PSTN to transmit appliance operational data. The transmission may be triggered when the appliance has attained a particular operating condition, or when a given time period has elapsed.

For all of the above methods, the criteria for determining that communication from the device is required can be one of the following: an alert condition has been satisfied; a pre-set time interval has expired since the last communication (one purpose for this periodic communication is to insure that communications is still possible); and the device has received a polling request to transmit an operating data file. Alternatively, raw data can of course be passed routinely at regular intervals or at the sampling rate of the sensors, without any preprocessing prior to transmission. If no preprocessing is required, the smart devices can be equipped merely for data collection and transmission.

At the remote analysis system, the following server components, Communications Server 42, Analysis Server 48, and Notification Server 52, are further described as follows:

Communication Server 42. Running software that receives operating data files or data streams from remote clients, and potentially from multiple networks. An IP address and connection receives data through the Internet. A X.25 port receives data directly from the wireless network NOC. A port connected to a modem bank collects data sent via the PSTN. Files or data blocks received from one of these networks are first checked against the Customer/Device database to confirm a valid transmission, and once confirmation is obtained, the file is posted to the Device Operating database. For devices that are scheduled for periodic posting, if a message is not received over a specified time, the server will initiate a “call” to the device. The server will also transmit new model matrix to a device, as appropriate.

Analysis Server 48. Running proprietary software, the server checks the Device Operating database 46 for new files, and when a new file is found, it runs a complete analysis on the data to determine if further action is required. The criteria for taking further action, for any given device, is found on the Customer/ Device database 44, which is individually set by the customer. If an alert condition is found by the Analysis Server 48, an action request is sent to the Notification Server 52.

Notification Server 52. Running proprietary software, the server checks for action requests from the Analysis Server 48. If a request is found, it checks the Customer/Device 44 database to get routing instructions. An entry is also made in a file, available for a remote analysis system analyst to review. Some actions may require a review by a remote analysis system Analyst prior to transmission. The server 52 will complete the notification procedure provided by the customer, which may include one or more of the following: an Internet based e-mail, a facsimile, a personal telephone call, or posted in a file for future download by the customer using remote analysis system proprietary software. The server 52 will also receive instructions from the customer (i.e., device notification instructions), and will post this information to the Customer/Device database 44.

Customer/Device Database 44. The database holds customer specific information, including points of contact, and all devices owned by the customer. For each device, the criteria for notifying the customer of alert conditions, and the method for doing so, will be stored.

Device Operating Database 46. The database holds all device operating data accepted by the Communication Server. It will also hold training data, the device model matrix, and past alert information.

Analyst Workstation 50. This workstation, connected to the remote analysis system Notification Server 52, allows a remote analysis system team member to review all alerts, operating data, device history, and configurations.

The customer can be notified by the remote analysis system of an alert, or communicate with either the remote analysis system and/or the device, through one or more of the following methods: e-mail via the Internet; facsimile; personal telephone call by an analyst; or subscriber dial-up.

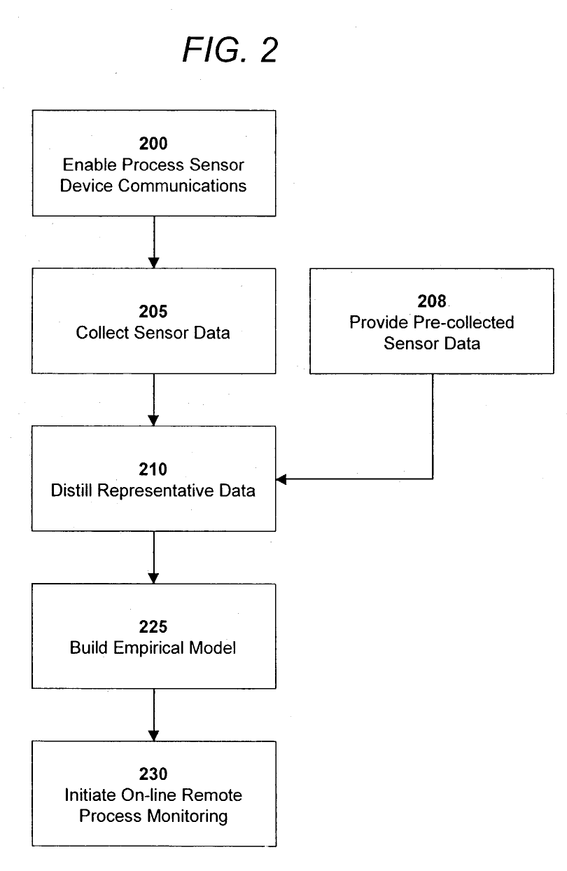

Turning to FIG. 2, a flowchart generally shows steps for implementing monitoring according to the present invention. The present invention may be used on a process, machine, system or other piece of equipment, whether mechanical, electrical or biological, only requiring that data from sensors or smart devices local to the monitored system can be communicated to the remote location of the remote analysis system. In Step 200, a process or machine to be monitored (in this figure a process) is provided with communication means for transmitting instrumented sensor data that measure various parameters of interest. In most circumstances, the process will already be instrumented with sensors for parameters that are already being used for control, but the process can be retrofitted with more sensors if desired. As shown in Step 205, sensor data is collected as the process is operated through all possible ranges of expected operation. Data collection can occur in batches over a period of time of normal operation, when the process is known to be in desired states of operation. Alternatively, the process can be ramped through various operational ranges specifically to generate and gather the data. In any case, at the end of some period of data collection, enough data has been collected on the process to sufficiently characterize the ranges of the process. Alternatively, as shown in Step 208, a batch of pre-collected data encapsulating those ranges can be provided to the analysis system. As shown in Step 210, one of several “training” methods can be used to distill the sensor data collected in Step 205 or 208 into a subset (the reference library) sufficient to represent the operational ranges and correlations between the sensors over those ranges. An example method for this is discussed in greater detail below.

As shown in Step 225, the distilled representative sensor data is used to build an empirical model in preparation for on-line monitoring. In Step 230, the monitoring system is turned on to provide on-line (optionally real-time) monitoring of the process using the empirical model afforded by the representative sensor data stored in memory. Live sensor data feeds over the above described communications links into the analysis system, which generates decisions in response thereto with reference to the reference library of distilled data, regarding the operational state of the process.

Turning again to the analysis server, a number of empirical modeling techniques can be employed to generate criteria on the basis of which to take further action. According to one embodiment, a process or machine can be monitored for process upsets, sensor failures and other impending faults, using an empirical model of the process or machine generated from sensor data gathered while the process or machine is operating in a satisfactory state.

The empirical model employs a similarity operator, in conjunction with a training set or reference library distilled from normal operating sensor data gathered as the process is operated through desirably monitored ranges of expected operation. The empirical model generates an estimate for the sensor values for the process or machine in response to receipt by the communication server input of the current actual sensor data from the remote process or machine as it operates. These estimates are compared to the actual sensor data in a sensitive statistical test, which provides indications of impending faults.

According to this similarity operator-based technique, for a given set of contemporaneous sensor data from the monitored process or machine running in real-time, the estimates for the sensors can be generated according to:

\vec{Y}_{estimated}=\vec{D}·\vec{W} (1)

where the vector Y of estimated values for the sensors is equal to the contributions from each of the snapshots of contemporaneous sensor values arranged to comprise matrix D (the reference library or reference set). These contributions are determined by weight vector W. The multiplication operation is the standard matrix/vector multiplication operator, or inner product. The vector Y has as many elements as there are sensors of interest in the remotely monitored process or machine for which estimates are sought. W has as many elements as there are reference snapshots in D. W is determined by:

$$\begin{matrix}\vec{W} = \frac{{\hat{W}}_{\to }}{( {\sum }_{j = 1}^{N} \hat{W} ( j ) )} & ( 2 ) \\ \hat{{W}_{\to }} = {( {\overline{D}}^{T} ⊗ \overline{D} )}^{- 1} \cdot ( {\overline{D}}^{T} ⊗ {\vec{Y}}_{in} ) & ( 3 )\end{matrix}$$

where the T superscript denotes transpose of the matrix, and Yᵢₙ is the current snapshot of actual transmitted (preferably real-time) sensor data. The similarity operator is symbolized in Equation 3, above, as the circle with the “X” disposed therein. Moreover, D is again the reference library as a matrix, and DT represents the standard transpose of that matrix (i.e., rows become columns). Yᵢₙ is the real-time or actual sensor values from the underlying system, and therefore is a vector snapshot.

As stated above, the symbol [symbol] represents the “similarity” operator, and could potentially be chosen from a variety of operators. In the context of the invention, this symbol should not to be confused with the normal meaning of designation of [symbol] , which is something else. In other words, for purposes of the present invention the meaning of [symbol] is that of a “similarity” operation.

The similarity operator, [symbol] , works much as regular matrix multiplication operations, on a row-to-column basis. The similarity operation yields a scalar value for each pair of corresponding n^{th} elements of a row and a column, and an overall similarity value for the comparison of the row to the column as a whole. This is performed over all row-to-column combinations for two matrices (as in the similarity operation on D and its transpose above).

By way of example, one similarity operator that can be used compares the two vectors (the ith row and jth column) on an element-by-element basis. Only corresponding elements are compared, e.g., element (i,m) with element (m,j) but not element (i,m) with element (n,j). For each such comparison, the similarity is equal to the absolute value of the smaller of the two values divided by the larger of the two values.

Hence, if the values are identical, the similarity is equal to one, and if the values are grossly unequal, the similarity approaches zero. When all the elemental similarities are computed, the overall similarity of the two vectors is equal to the average of the elemental similarities. A different statistical combination of the elemental similarities can also be used in place of averaging, e.g., median.

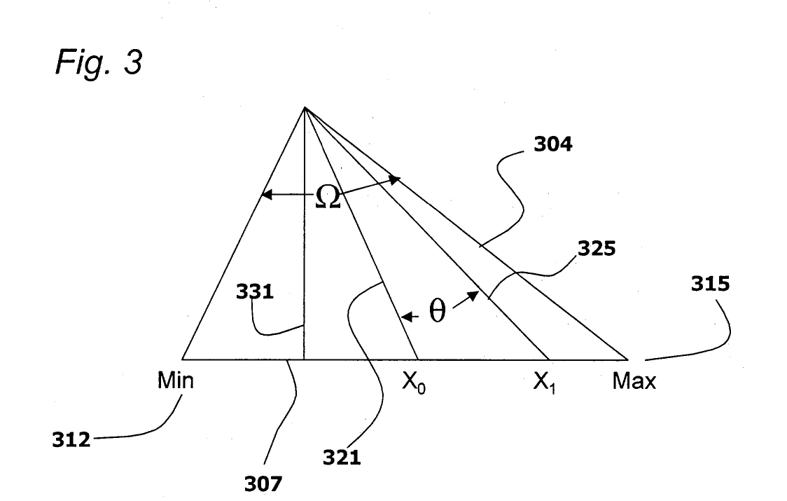

Another example of a similarity operator that can be used can be understood with reference to FIG. 3. With respect to this similarity operator, the teachings of U.S. Pat. No. 5,987,399 to Wegerich et al., co-pending U.S. application Ser. No. 09/795,509 to Wegerich et al., and co-pending U.S. application Ser. No. 09/780,561 to Wegerich et al. are relevant, and are incorporated herein by reference. For each sensor or physical parameter, a triangle 304 is formed to determine the similarity between two values for that sensor or parameter. The base 307 of the triangle is set to a length equal to the difference between the minimum value 312 observed for that sensor in the entire training set, and the maximum value 315 observed for that sensor across the entire training set. An angle Ω is formed above that base 307 to create the triangle 304. The similarity between any two elements in a vector-to-vector operation is then found by plotting the locations of the values of the two elements, depicted as X₀ and X₁ in the figure, along the base 307, using at one end the value of the minimum 312 and at the other end the value of the maximum 315 to scale the base 307.

Line segments 321 and 325 drawn to the locations of X₀ and X₁ on the base 307 form an angle θ. The ratio of angle θ to angle Ω gives a measure of the difference between X₀ and X₁ over the range of values in the training set for the sensor in question. Subtracting this ratio, or some algorithmically modified version of it, from the value of one yields a number between zero and one that is the measure of the similarity of X₀ and X₁.

Yet another example of a similarity operator that can be used determines an elemental similarity between two corresponding elements of two observation vectors or snapshots, by subtracting from one a quantity with the absolute difference of the two elements in the numerator, and the expected range for the elements in the denominator. The expected range can be determined, for example, by the difference of the maximum and minimum values for that element to be found across all the reference library data. The vector similarity is then determined by averaging the elemental similarities.

In yet another similarity operator that can be used in the present invention, the vector similarity of two observation vectors is equal to the inverse of the quantity of one plus the magnitude Euclidean distance between the two vectors in n-dimensional space, where n is the number of elements in each observation, that is, the number of sensors being observed. Thus, the similarity reaches a highest value of one when the vectors are identical and are separated by zero distance, and diminishes as the vectors become increasingly distant (different).

Other similarity operators are known or may become known to those skilled in the art, and can be employed in the present invention as described herein. The recitation of the above operators is exemplary and not meant to limit the scope of the claimed invention. In general, the following guidelines help to define a similarity operator for use in the invention as in equation 3 above and elsewhere described herein, but are not meant to limit the scope of the invention:

1. Similarity is a scalar range, bounded at each end.

2. The similarity of two identical inputs is the value of one of the bounded ends.

3. The absolute value of the similarity increases as the two inputs approach being identical.

Accordingly, for example, an effective similarity operator for use in the present invention can generate a similarity of ten (10) when the inputs are identical, and a similarity that diminishes toward zero as the inputs become more different. Alternatively, a bias or translation can be used, so that the similarity is 12 for identical inputs, and diminishes toward 2 as the inputs become more different. Further, a scaling can be used, so that the similarity is 100 for identical inputs, and diminishes toward zero with increasing difference. Moreover, the scaling factor can also be a negative number, so that the similarity for identical inputs is −100 and approaches zero from the negative side with increasing difference of the inputs. The similarity can be rendered for the elements of two vectors being compared, and summed or otherwise statistically combined to yield an overall vector-to-vector similarity, or the similarity operator can operate on the vectors themselves (as in Euclidean distance). A few examples of legitimate similarity operators include (from dissimilar to similar): from 0 to 10, from 5 to 10, from 0 to −3, from −1 to −5, and discrete steps through 0, 2, 5, 8, 10.

Significantly, the present invention can be used for monitoring variables in an autoassociative mode or an inferential mode. In the autoassociative mode, model estimates are made of variables that also comprise input to the model. In the inferential mode, model estimates are made of variables that are not present in the input to the model. In the inferential mode, equation 1 above becomes:

\vec{Y}_{estimated}=\vec{D}ₒᵤₜ·\vec{W} (4)

and equation 3 above becomes:

[symbol]

=(\overline{D}ᵢₙ^{T} [symbol] \overline{D}ᵢₙ)⁻¹·(\overline{D}ᵢₙ^{T} [symbol] \vec{Y}ᵢₙ) (5)

where the D matrix has been separated into two matrices Dᵢₙ and Dₒᵤₜ, according to which rows are inputs and which rows are outputs, but column (observation) correspondence is maintained.

Another example of an empirical modeling method that can be used in the present invention is kernel regression, or kernel smoothing. A kernel regression can be used to generate an estimate based on a current observation in much the same way as the similarity-based model, which can then be used to generate a residual as detailed elsewhere herein. Accordingly, the following Nadaraya-Watson estimator can be used:

$$\hat{y} ( \vec{X} , h ) = \frac{{\sum }_{i = 1}^{n} {K}_{h} ( \vec{X} - {\vec{X}}_{i} ) {y}_{i}}{{\sum }_{i = 1}^{n} {K}_{h} ( \vec{X} - {\vec{X}}_{i} )} \qquad ( 6 )$$

where in this case a single scalar inferred parameter y-hat is estimated as a sum of weighted exemplar yᵢ from exemplar data, where the weight it determined by a kernel K of width h acting on the difference between the current observation X and the exemplar observations Xᵢ corresponding to the yᵢ from exemplar data. The independent variables Xᵢ can be scalars or vectors. Alternatively, the estimate can be a vector, instead of a scalar:

$${\vec{Y}}_{estimated} ( \vec{X} , h ) = \frac{{\sum }_{i = 1}^{n} {K}_{h} ( \vec{X} - {\vec{X}}_{i} ) {\vec{Y}}_{i}}{{\sum }_{i = 1}^{n} {K}_{h} ( \vec{X} - {\vec{X}}_{i} )} \qquad ( 7 )$$

Here, the scalar kernel multiplies the vector Yᵢ to yield the estimated vector.

A wide variety of kernels are known in the art and may be used. One well-known kernel, by way of example, is the Epanechnikov kernel:

$${K}_{h} ( u ) = \{ \begin{matrix}\frac{3}{4 h} ( 1 - {u}^{2} / {h}^{2} ) ; & \vert u \vert \leq h \\ 0 ; & \vert u \vert > h\end{matrix} \qquad ( 8 )$$

where h is the bandwidth of the kernel, a tuning parameter, and u can be obtained from the difference between the current observation and the exemplar observations as in equation 6. Another kernel of the countless kernels that can be used in remote monitoring according to the invention is the common Gaussian kernel:

$${K}_{h} ( \vec{X} - {\vec{X}}_{i} ) = \frac{1}{\sqrt{2}} {ⅇ}^{\frac{- {( \vec{X} - {\vec{X}}_{i} )}^{2}}{2}} \qquad ( 9 )$$

The constitution of the matrix D of reference data can be accomplished according to a number of techniques. The main objective is that the D matrix contains data that is representative of normal or desired operation. Under some circumstances, D can contain all available reference data. For reasons of computational burden, this may not be feasible, and therefore a subset of available reference data may be selected to sufficiently characterize the modeled system. Thus, D may be selected from reference data based on a “training” technique that selects a subset of reference observations for use throughout monitoring. Alternatively, the selection of the subset of reference observations can be made “on-the-fly” with each observation, if need be.

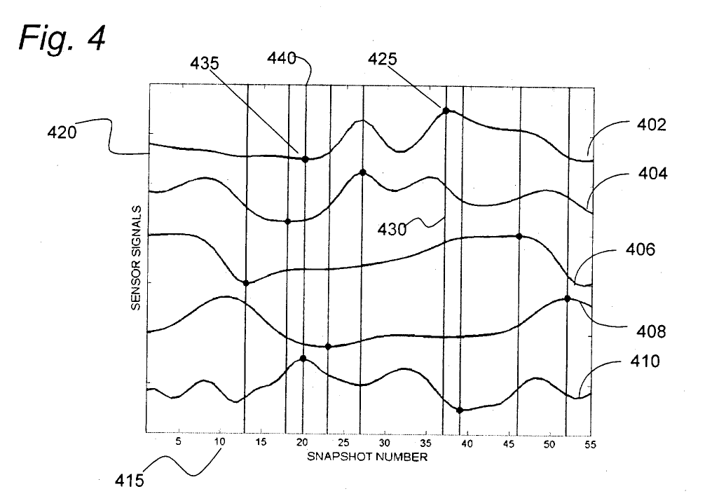

An example of a method for training the empirical model is graphically depicted in FIG. 4, wherein collected sensor data for the remotely monitored process or machine is distilled to create a representative training data set, the reference library. Five sensor signals 402, 404, 406, 408 and 410 are shown for a process or machine to be monitored, although it should be understood that this is not a limitation on the number of sensors that can be monitored using the present invention. The abscissa axis 415 is the sample number or time stamp of the collected sensor data, where the data is digitally sampled and the sensor data is temporally correlated. The ordinate axis 420 represents the relative magnitude of each sensor reading over the samples or “snapshots”. Each snapshot represents a vector of five elements, one reading for each sensor in that snapshot. Of all the previously collected sensor data representing normal or acceptable operation, according to this training method, only those five-element snapshots are included in the representative training set that contain either a minimum or a maximum value for any given sensor.

Therefore, for sensor 402, the maximum 425 justifies the inclusion of the five sensor values at the intersections of line 430 with each sensor signal, including maximum 425, in the representative training set, as a vector of five elements. Similarly, for sensor 402, the minimum 435 justifies the inclusion of the five sensor values at the intersections of line 440 with each sensor signal.

Upon providing an estimate from an empirical model of the remotely monitored process or machine, the estimated sensor values or parameters are compared using a decision technique to the actual sensor values or parameters that were received from the remote process or machine. Such a comparison has the purpose of providing an indication of a discrepancy between the actual values and the expected values that characterize the operational state of the process or machine. Such discrepancies are indicators of sensor failure, incipient process upset, drift from optimal process targets, incipient mechanical failure, and so on.

One such decision technique that can be employed is called a sequential probability ratio test (SPRT), and is described in the aforementioned U.S. Pat. No. 5,764,509 to Gross et al. Broadly, for a sequence of estimates for a particular sensor, the test is capable of determining with preselected missed and false alarm rates whether the estimates and actuals are statistically the same or different, that is, belong to the same or to two different Gaussian distributions.

The SPRT type of test is based on the maximum likelihood ratio. The test sequentially samples a process at discrete times until it is capable of deciding between two alternatives: H₀:μ=0; and H₁:μ=M. In other words, is the sequence of sampled values indicative of a distribution around zero, or indicative of a distribution around some non-zero value? It has been demonstrated that the following approach provides an optimal decision method (the average sample size is less than a comparable fixed sample test). A test statistic, Φₜ, is computed from the following formula:

$${Ψ}_{t} = {\sum }_{i = 1 + j}^{t} ln [ \frac{{f}_{H1} ( {y}_{i} )}{{f}_{H0} ( {y}_{i} )} ] \qquad ( 10 )$$

where In( ) is the natural logarithm, f_{Hs}( ) is the probability density function of the observed value of the random variable Yᵢ under the hypothesis Hₛ and j is the time point of the last decision.

In deciding between two alternative hypotheses, without knowing the true state of the signal under surveillance, it is possible to make an error (incorrect hypothesis decision). Two types of errors are possible. Rejecting H₀ when it is true (type I error) or accepting H₀ when it is false (type II error). Preferably these errors are controlled at some arbitrary minimum value, if possible. So, the probability of a false alarm or making a type I error is termed α, and the probability of missing an alarm or making a type II error is termed β. The well-known Wald's Approximation defines a lower bound, L, below which one accepts Ho and an upper bound, U above which one rejects H₀.

$$\begin{matrix}U = ln [ \frac{1 - β}{α} ] & ( 11 ) \\ L = ln [ \frac{β}{1 - α} ] & ( 12 )\end{matrix}$$

Decision Rule: if 101 ₜ≦L, then ACCEPT H₀; else if Φₜ≧U, then REJECT H₀; otherwise, continue sampling.

To implement this procedure, this distribution of the process must be known. This is not a problem in general, because some a priori information about the system exists. For most purposes, the multivariate Gaussian distribution is satisfactory, and the SPRT test can be simplified by assuming a Gaussian probability distribution p:

$$p = \frac{1}{σ \sqrt{2 π}} {ⅇ}^{[ - \frac{{( x - μ )}^{2}}{2 {σ}^{2}} ]} \qquad ( 13 )$$

Then, the test statistic for a typical sequential test deciding between zero-mean hypothesis H₀ and a positive mean hypothesis H₁ is:

$${Ψ}_{t + 1} = {Ψ}_{t} + \frac{M}{{σ}^{2}} ( {y}_{t } - \frac{M}{2} ) \qquad ( 14 )$$

where M is the hypothesized mean (typically set at a standard deviation away from zero, as given by the variance), σ is the variance of the training residual data, and yₜ is the input value being tested. Then the decision can be made at any observation t+1 in the sequence according to:

1. If Φₜ₊₁≦ln(β/(1−α)), then accept hypothesis H₀ as true;

2. If Φₜ₊₁≧ln((1−β)/α), then accept hypothesis H₁ as true; and

3. If ln(β/(1−α))<Φₜ₊₁<ln((1−β)/α), then make no decision and continue sampling.

The SPRT test can run against the residual for each monitored parameter, and can be tested against a positive biased mean, a negative biased mean, and against other statistical moments, such as the variance in the residual.

Other statistical decision techniques can be used in place of SPRT to determine whether the remotely monitored process or machine is operating in an abnormal way that indicates an incipient fault. According to another technique, the estimated sensor data and the actual sensor data can be compared using the similarity operator to obtain a vector similarity. If the vector similarity falls below a selected threshold, an alert can be indicated and action taken to notify an interested party as mentioned above that an abnormal condition has been monitored.

According to yet another embodiment of the present invention, a modified version of SPRT can be used to monitor and decide whether fault indications are present in the monitored sensor data. This modified form of SPRT is discussed in co-pending U.S. patent application Ser. No. 08/970,873 to Gross et al., for “System for Surveillance of Spectral Signals”, the teachings of which are incorporated herein by reference. According to that modified SPRT technique, which can be carried out in either the time domain or “spectral” domain (frequency, curve shape, etc.), collected data from at least one sensor detecting a complex signal is distilled into an average or typical periodic signal profile, as for example an averaged heart beat, a vibration spectral pattern, and the like. The periodic signal is sampled at some rate, and the variance and mean for each sample in the averaged signal is computed from the collected data. The above SPRT technique is applied to sequences of samples (frequency domain) or sequences of observations from the same sample slice in the period, and the mean and variance appropriate to each sample is used:

$$\begin{matrix}{Ψ}_{t + 1} ( k ) = {Ψ}_{t} ( k ) + \frac{M ( k )}{{σ ( k )}^{2}} ( {y}_{t} ( k ) - \frac{M ( k )}{2} ) & ( 15 ) \\ {Ψ}_{t} ( k ) = {Ψ}_{t} ( k - 1 ) + \frac{M ( k )}{{σ ( k )}^{2}} ( {y}_{t} ( k ) - \frac{M ( k )}{2} ) & ( 16 )\end{matrix}$$

where Equation 15 is a sequence in time for a given sample slice, and Equation 16 is a sequence across the spectrum or periodic signal shape from one sample slice to the next. Note that for a given periodic signal, at the end of a single period, a decision may be made as to the sameness or difference of that signal as against the stored average signal, when using Equation 16. While a decision of this type may be possible using Equation 15, typically the decision can only be rendered after repeated periods through time.

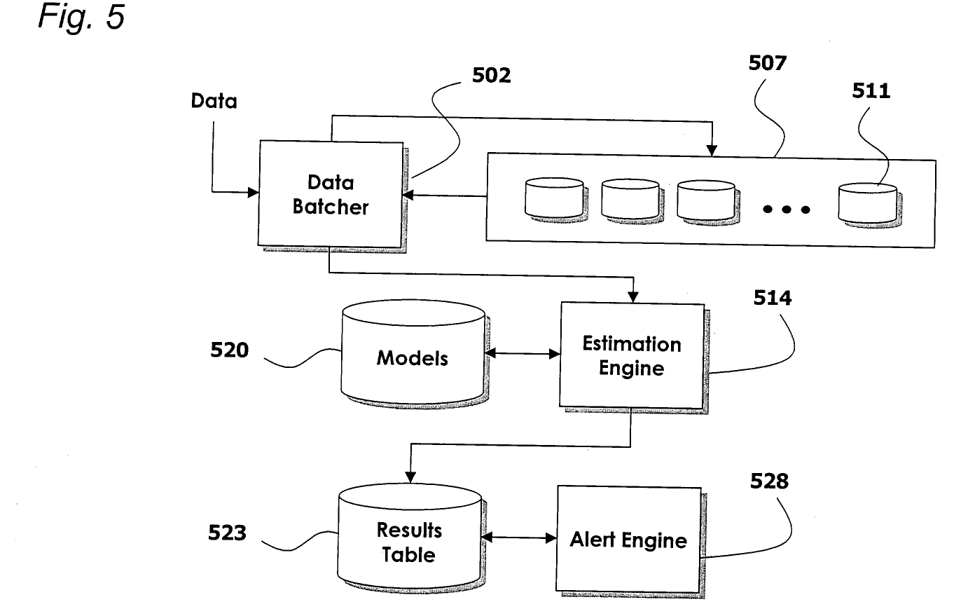

In practice, when a large number of assets is monitored, the potential is created for overwhelming the analysis server with both incoming data as well as the need to call up the individual models that apply to each asset. In addition, the asynchronous nature of Internet communications poses issues where data arrives out of order. Therefore, techniques are needed to organize the incoming data to make for efficient processing, while still delivering the requirements of real-time output. Turning to FIG. 5, an architecture is provided for effective handling of data when monitoring multiple pieces of equipment, such as the turbines in a fleet of aircraft. Data arriving at the location of the application service provider via wireless, PSTN, Internet or otherwise is first directed to a data batcher 502, which is disposed to accumulate data in a store 507 arranged in bins 511, one bin per monitored asset. When data in any particular one of bins 511 is ready for processing, the data batcher 502 creates a data message with a defined format containing the binned data in proper time-stamped order as appropriate, and header information with asset identification and identification of the model to be used. It then passes the data message to the estimation engine 514, which reads the header and obtains the appropriate asset model from the model table 520 to process the data. The estimation engine 514 generates estimates of the current state of the monitored equipment or process, as well as residuals between those estimates and actual raw data, and writes them to a results table 523. In addition, alerts based on these data can also be generated by the estimation engine and stored in the results table. Alternatively, a separate alert engine 528 can be used to independently mine the results table 523 and generate alerts based on the raw values, estimates and residuals therein, which can be stored back into the results table 523. The advantage of using the separate alert engine 528 is that the analysis of the estimates and residuals can take place independent in time from the generation of the estimates by the estimation engine 514, for example even much later when a human operator wants to see the analysis. The estimation process using the nonparametric regression techniques of the present invention is a process that is independent of the sequence of observations, and so can even be executed out of time sequence, whereas the analysis process (e.g., SPRT and the like) is typically cumulative over a window where the sequence of observations is critical. By decoupling the estimation engine 514 from the alert engine 528, the invention is made further resilient in the face of the asynchronous arrival of data over, say, the Internet, because if a data observation is particularly delayed, even beyond the processing event of the data in a bin 511, the estimation engine can post hoc add the estimates to the results table 523 without consequence.

Data batcher 502 can employ several methods for determining when the data in a bin 511 is ready to be processed by the estimation engine. In a first method, the data batcher cycles through all the bins regularly, and creates a data message for the estimation engine from whatever data has accumulated therein up to the point at which the bin is addressed. According to a second method, the data batcher generates a data message from the data in a given bin according to a schedule, wherein the frequency of this may differ among the bins, as when the data rates for the different assets corresponding to the bins is different. According to a third method, each bin has an enforced data capacity, and when that capacity is reached, the bin is emptied to create the data message. This is most useful when the data rate for an asset or piece of monitored equipment varies. According to a fourth method, the data batcher may also monitor the incoming data to look for a flag or trigger value that indicates whatever data has been accumulated should be processed now. In this way, the processing of data for monitoring can be controlled indirectly from the remote location of the monitored equipment. As a variation on this, a fifth way is for the data batcher to monitor the incoming data to observe when particular data crosses a threshold, indicating a certain condition that should trigger the processing of accumulated data.

Advantageously, by creating the data messages in this “quasi-batch” mode, the efficiency of the estimation engine (and the entire analysis server) is greatly improved, because both larger quantities of data are handled at once, and the estimation engine does not spend as much time swapping in and out the various models for the monitored assets. The frequency with which the bins 511 are emptied and their data processed must, however be sufficiently fast to provide for monitoring results that are substantially real-time, or at least timely enough to be acted on by persons responsible for using the monitored data. A further advantage is that the data received over an asynchronous messaging medium like the Internet can be organized in the right sequence, even though the data may have arrived out of sequence. If missing values are determined, the data batcher can notify the administrator or users, or substitute interpolated values. By using a separate alert engine, the tolerance of the inventive system to out-of-sequence data can still further be improved, because the estimation engine can fill in delayed estimates even after processing the batch in which the delayed values should have been, independent of the time-sensitive and sequence-sensitive tests of the alert engine.

It should be appreciated that a wide range of changes and modifications may be made to the embodiments of the invention as described herein. Thus, it is intended that the foregoing detailed description be regarded as illustrative rather than limiting and that the following claims, including all equivalents, are intended to define the scope of the invention.

What is claimed is:

1. A wide-area network enabled equipment condition monitoring system for remotely located machines and processes, comprising:
a data acquisition device operable at a remote site to collect sensor signals indicative of operation of at least one machine at the site;
a communications network for conveying the collected signals to an analysis site; and
an analysis server operable at the analysis site responsive to conveyed signals for condition monitoring of the at least one machine using an empirical model to generate estimates of at least one variable reflecting the operation of the at least one machine.

2. A system according to claim 1 further comprising an device operating database for storing reference observations corresponding to the empirical model of the at least one machine.

3. A system according to claim 2 wherein the empirical model used by said analysis server is a similarity-based model.

4. A system according to claim 2 wherein the empirical model used by said analysis server is a kernel regression-based model.

5. A system according to claim 1 wherein said analysis server comprises a decision engine for comparing the estimates and the conveyed signals to determine whether a deviation exists.

6. A system according to claim 5 wherein said decision engine employs a sequential probability ratio test for deciding whether a deviation exists.

7. A system according to claim 6 wherein said sequential probability ratio test is employed against a temporal sequence of values.

8. A system according to claim 6 wherein said sequential probability ratio test is employed against a sequence of samples defining a periodic signal shape.

9. A system as recited in claim 1 wherein said communications network comprises a telephony network such as a public switch telephone network (PSTN).

10. A system as recited in claim 1 wherein said communications network comprises a wide area network (WAN) comprising an intranet or an internet network.

11. A system according to claim 1 further comprising a notification server responsive to said analysis server for completing an equipment condition notification procedure for a customer subscribing for condition monitoring of the machine.

12. A system according to claim 11 further comprising a customer/device database relating identity of a remotely monitored machine with a notification procedure desired by a customer.

13. A system as recited in claim 12 wherein said notification server completes the notification procedure for the customer via electronic or telephonic methods.

14. A condition monitoring system for remote assets such as machines and processes, using data conveyed asynchronously, comprising:
a data store operable to store data from at least one remote site, said data including sensor data indicative of operation of a plurality of monitored assets, and to accumulate received sensor data in separate logical bins for each monitored asset to which the sensor data corresponds;
a batching module for evaluating whether a condition has been met regarding sensor data accumulated in a bin for a monitored asset;
an estimation engine responsive to a condition-satisfied evaluation by the batching module for processing the sensor data accumulated in the bin to generate estimates for at least one variable reflecting the operation of the monitored asset; and
an alert engine for generating messages indicative of asset condition, responsive to the generated estimates.

15. A system as recited in claim 14 wherein said batching module evaluates for a bin the condition that a predetermined amount of time has elapsed.

16. A system as recited in claim 14 wherein said batching module evaluates for a bin the condition that a predetermined amount of data has accumulated in the bin.

17. A system as recited in claim 14 wherein said batching module evaluates for a bin the condition that received data has taken on a particular value.

18. A system as recited in claim 14 wherein said batching module evaluates for a bin the condition that received data has crossed a particular threshold value.

19. A system as recited in claim 14 wherein said batching module evaluates for a bin the condition that the bin is next in a processing order of bins.

20. A system according to claim 14 wherein said estimation engine uses an empirical model of normal operation of the monitored asset.

21. A system according to claim 20 wherein the empirical model is a kernel regression-based model.

22. A system according to claim 20 wherein the empirical model is a similarity-based model.

23. A system according to claim 20 wherein the alert engine generates a message when a deviation is detected between the generated estimates and corresponding sensor data.

24. A system according to claim 23 wherein the alert engine employs a sequential probability ratio test to detect a deviation between the generated estimates and corresponding sensor data.

25. A system as recited in claim 14 comprising a logical results table intermediate said estimation engine and said alert engine for storing estimates and other results from said estimation engine independent from processing of the estimates and other results by said alert engine, to facilitate asynchronous arrival of data.
